(19) United States
(12) Patent Application Publication
(10) Pub. No.: US 2013/0022257 A1
(43) Pub. Date: Jan. 24, 2013

(54) SYSTEMS AND METHODS FOR AUTOMATIC GENERATION OF MEDICAL IMAGE SHEETS

(71) Applicants: Jon Charles Omernick, Wauwatosa, WI (US); Daniel Mabini, Waukesha, WI (US); Teri Fischer, Waukesha, WI (US)

(72) Inventors: Jon Charles Omernick, Wauwatosa, WI (US); Daniel Mabini, Waukesha, WI (US); Teri Fischer, Waukesha, WI (US)

(73) Assignee: General Electric Company, Schenectady, NY (US)

(21) Appl. No.: 13/186,081

(22) Filed: Jul. 19, 2011

(51) Int. Cl. G06K 9/00

(52) U.S. Cl. 382/132

(57) ABSTRACT

Medical imaging systems including an operator workstation and control circuitry are provided. The operator workstation is adapted to enable an operator to operate a medical imaging device in accordance with operator preferences, and the control circuitry is adapted to display an operator interface on a display portion of the operator workstation to enable an autofilling option for the operator. When the operator selects the autofilling option, the control circuitry is adapted to automatically populate a sheet with a series of acquired medical images in a spatial arrangement determined based on predetermined preferences.

### BACKGROUND OF THE INVENTION

The subject matter disclosed herein generally relates to medical imaging systems and, more particularly, to systems and methods for automatically generating sheets of medical images in accordance with a set of guidelines.

A wide range of tissues may be imaged in a medical field through the use of various types of imaging systems. Many different types of imaging systems have been developed and refined, including X-ray systems, which have moved from film-based systems to digital X-ray. These digital X-ray systems are widely employed in medical environments, such as hospitals, to acquire image data corresponding to a region of interest in a patient. Once acquired, this image data is typically transferred to an operator workstation, and a medical operator (e.g., a radiologist, medical technician, nurse, etc.) may manipulate the acquired data for viewing and/or printing.

In many applications, the image data available for manipulation by the medical operator is obtained through more than one imaging modality. For example, a portion of the image data may have been obtained by a digital radiography system, while the remaining portion of the image data may have been acquired via use of a fluoroscopy system. In these instances, if the medical operator would like to transfer portions of the images (e.g., to a hospital network) or print subsets of the images, the medical operator must choose certain subsets of the data and manually position those subsets in a desired arrangement on a printer sheet or display screen for printing or transfer. However, this process is often inefficient due to the large quantity of images that are generated from these imaging operations, thus requiring substantial amounts of time for the medical operator to sort through and position the desired images.

### BRIEF DESCRIPTION OF THE INVENTION

In an embodiment, a medical imaging analysis method includes the steps of receiving a data input indicative of one or more image display preferences, receiving image data encoding medical images in one or more formats from one or more radiographic imaging operations, receiving input from an operator enabling an autofill operation, and automatically populating one or more sheets with a subset of the image data in a spatial arrangement determined by the one or more image display preferences.

In another embodiment, a medical imaging system includes an imager adapted to acquire image data indicative of a region of interest in a patient and an operator interface adapted to receive one or more operator selections corresponding to operator printing and/or display preferences for the acquired image data. The medical imaging system also includes control circuitry communicatively coupled to the operator interface and adapted to display an autofill selector on the operator interface to enable the operator to select an autofill option. When the operator enables the autofill option, the control circuitry is adapted to automatically populate one or more sheets with a subset of the image data in a spatial arrangement determined by the one or more operator selections.

In another embodiment, a medical imaging system includes an operator workstation adapted to enable an operator to operate a medical imaging device in accordance with operator preferences and control circuitry adapted to display an operator interface on a display portion of the operator workstation to enable an autofilling option for the operator. When the operator selects the autofilling option, the control circuitry is adapted to automatically populate a sheet with a series of acquired medical images in a spatial arrangement determined based on predetermined preferences.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of an X-ray system operable in accordance with aspects of the present technique;

FIG. 2 is a block diagram of the X-ray system illustrated in FIG. 1 showing components included in an embodiment of the X-ray system;

FIG. 3 is a flow chart illustrating a method for generating automatically populated sheets of medical images in accordance with an embodiment;

FIG. 4 is a flow chart illustrating a method for generating automatically populated sheets of radiographic and fluoroscopic images in accordance with an embodiment; and

FIG. 5 illustrates an operator interface including an autofill selector in accordance with an embodiment.

### DETAILED DESCRIPTION OF THE INVENTION

As described in detail below, methods and systems are provided for the automatic generation of one or more sheets having medical images spatially arranged in a manner determined by preset preferences. To that end, presently disclosed embodiments may display an autofill option on an operator interface of a medical imaging system that enables the system operator (e.g., a radiologist or other medical technician) to enable the system circuitry to operate in an autofill mode. Once placed in the autofill mode, the system circuitry is adapted to receive images in multiple formats and/or from multiple types of imaging operations and to automatically populate the sheets with the received images. The sheets may be electronic sheets that are displayable, for example, on a monitor of an operator workstation, or physical sheets that are generated by a printing device. Further, once the sheets are automatically populated, certain embodiments may provide for updates or changes to be made by the operator before or after the sheets have been exported.

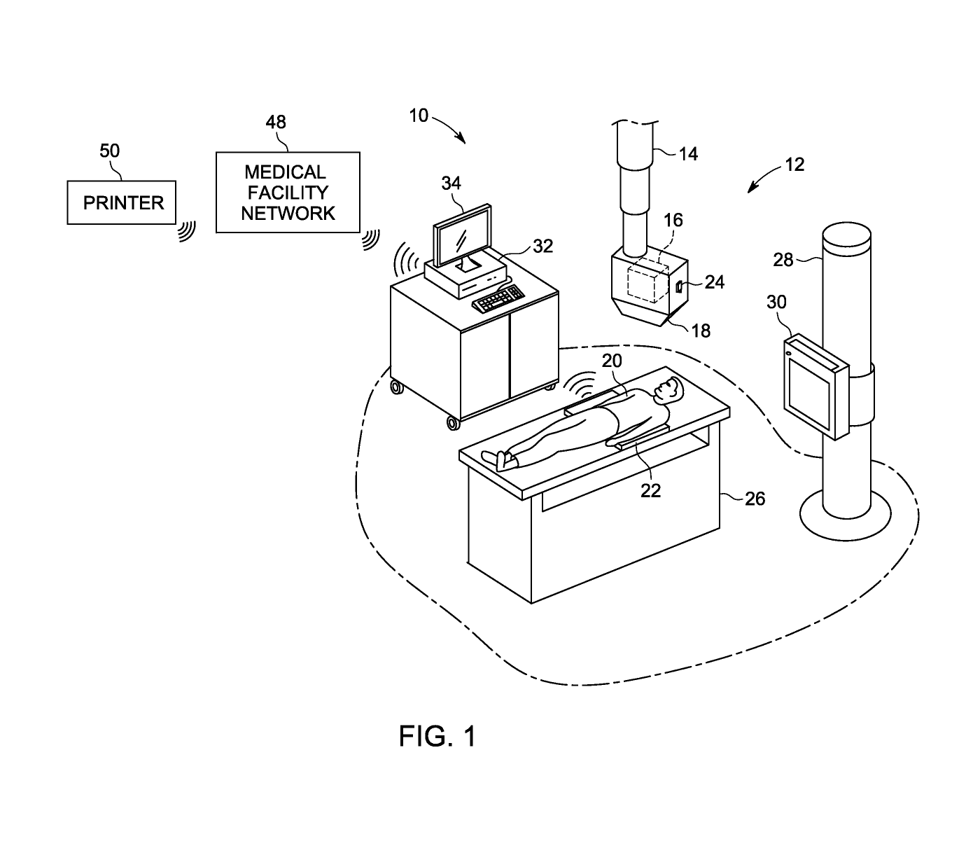

Turning now to the drawings, FIG. 1 illustrates an embodiment of an X-ray system 10 that is operable in accordance with presently disclosed techniques. In the depicted embodiment, the X-ray system 10 may be a digital or analog X-ray system. The X-ray system 10 is designed to acquire original images or image data and to process the image data for display (e.g., in a digital X-ray system) and/or printing in an automatically determined spatial arrangement on one or more electronic or physical sheets in accordance with embodiments of the presently disclosed techniques.

The illustrated X-ray system 10 includes an imaging system 12. The imaging system 12 includes an overhead tube support arm 14 for positioning a radiation source 16, such as an X-ray tube, and a collimator 18 with respect to a patient 20 and an image receptor 22. In analog X-ray systems 10, the image receptor 22 may include a radiographic film and cassette, phosphorescent screen and computed radiography cassette, or other devices. In digital X-ray systems, the image receptor 22 may include a digital X-ray detector. The imaging system 12 may also include a camera 24 to help facilitate the positioning of the radiation source 16 and collimator 18.

Moreover, in one embodiment, the imaging system 12 may be used in combination with one or both of a patient table 26 and a wall stand 28 to facilitate image acquisition. Particularly, the table 26 and the wall stand 28 may be configured to receive image receptor 22. For instance, image receptor 22 may be placed on an upper, lower, or intermediate surface of the table 26, and the patient 20 (more specifically, a region of interest of the patient 20) may be positioned on the table 26 between the image receptor 22 and the radiation source 16. Also, the wall stand 28 may include a receiving structure 30 adapted to receive the image receptor 22, and the patient 20 may be positioned adjacent the wall stand 28 to enable the image or image data to be acquired via the image receptor 22. The receiving structure 30 may be moved vertically along the wall stand 28 in certain embodiments.

Also depicted in FIG. 1, the imaging system 12 includes a workstation 32 and display 34. In one embodiment, the workstation 32 may include or provide the functionality of the imaging system 12 such that a user, by interacting with the workstation 32, may control operation of the source 16 and detector 22 (in a digital X-ray system). For example, in some embodiments, the user may utilize the operator workstation 32 to prepare the imaging system 12 for an exposure and, subsequently, to initiate the exposure. For further example, an operator interface (e.g., displayed on display 34) of the workstation 32 may be configured to receive a user-input command for operation of the imaging system 12 (e.g., changing X-ray source settings or moving the receiving structure 30 along the wall stand 28) prior to initiation of an X-ray exposure sequence. Further, the workstation 32 may transmit the commands received via the operator interface shown on the display 34 to the imaging system 12 (e.g., via a wireless signal). In response to the received instructions, the imaging system 12 executes the commands and performs an imaging operation to acquire image data.

Once the data is acquired, the imaging system 12 is configured to communicate the image data corresponding to one or more regions of interest of the patient 20 to a variety of other suitable systems or devices, such as a medical facility network 48 and/or a printing device 50. The medical facility network 48 may include a hospital information system (HIS), a radiology information system (RIS), and/or a picture archiving communication system (PACS). However, in certain embodiments, prior to transmitting the image data, control circuitry disposed, for example, in the operator workstation 32 may be configured to automatically spatially arrange portions of the image data (e.g., subsets of images corresponding to particular views of the patient) on one or more sheets based on previously received or stored guidelines or preferences. Further, the control circuitry may be adapted to define an order in which the portions of the image data are transmitted. These and other functionalities of the control circuitry are described in more detail below.

In some embodiments, the imaging system 12 may be a stationary system disposed in a fixed X-ray imaging room, such as that generally illustrated in FIG. 1. It will be appreciated, however, that the presently disclosed techniques may also be employed with other imaging systems, including mobile X-ray units and systems, in other embodiments. Indeed, in certain embodiments, a single workstation 32 may include control circuitry that receives image data from a variety of different types of imaging systems, such as digital radiography systems, analog radiography systems, fluoroscopy systems, or a combination thereof. As such, the control circuitry may automatically populate one or more electronic or physical sheets with portions of data acquired from different modalities or in different formats in accordance with received or stored guidelines. As such, the X-ray imaging system 12 shown in FIG. 1 is merely an example, and the presently disclosed techniques are contemplated for use with a variety of suitable systems.

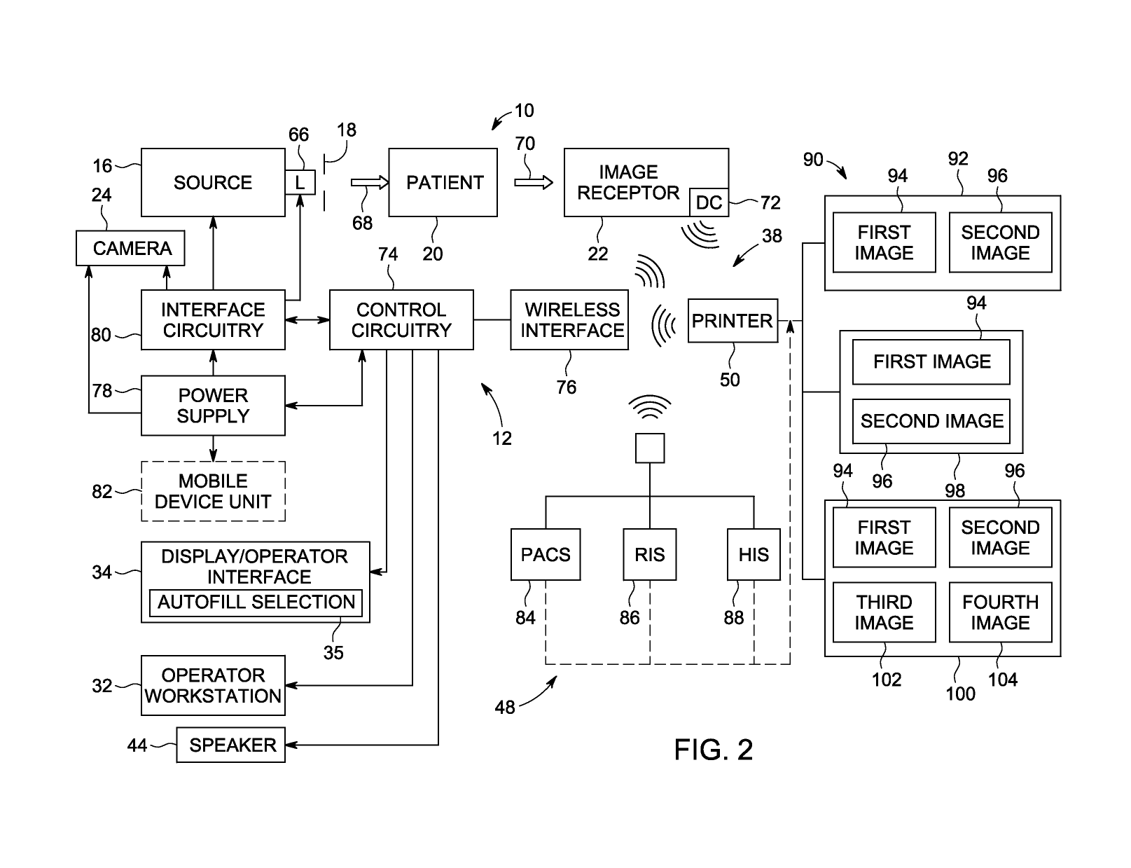

FIG. 2 is a diagrammatical illustration of components of an embodiment of the X-ray system 10 shown in FIG. 1. As illustrated in FIG. 2, the X-ray system 10 includes the source of X-ray radiation 16 positioned adjacent to the collimator 18. A light source 66, also known as a collimator light, is positioned between the X-ray source 16 and the collimator 18. The collimator 18 permits a stream of radiation 68 or light to be directed to a specific region in which an object or subject, such as the patient 20, is positioned. A portion 70 of the radiation passes through or around the subject and impacts the image receptor or digital X-ray detector 22. As will be appreciated by those skilled in the art, the detector 22 in digital X-ray systems 10 converts the X-ray photons received on its surface to lower energy photons, and, subsequently, to electric signals, which are acquired and processed to reconstruct an image of the features within the subject. The collimator light 66 in the collimator 18 directs light onto the same area where the X-ray photons will pass and can be used to position the patient 20 before exposure. The collimator light 66 can be turned on and off via a user input received through an operator interface displayed on the imaging system 12.

Moreover in digital X-ray systems, the detector 22 is coupled to a detector controller 72 which commands acquisition of the signals generated in the detector 22. The detector controller 72 may also execute various signal processing and filtration functions, such as for initial adjustment of dynamic ranges, interleaving of digital image data, and so forth. The detector controller 72 is responsive to signals from control circuitry 74 communicated wirelessly via a wireless interface 76. In general, the control circuitry 74 commands operation of the imaging system 12 to execute examination protocols and to process acquired image data. For example, the control circuitry 74 may automatically populate one or more sheets with image data spatially arranged in a manner determined by previously received or stored guidelines or operator preferences. In the present context, the control circuitry 74 also includes signal processing circuitry, typically based upon a programmed general purpose or application-specific digital computer; and associated devices, such as optical memory devices, magnetic memory devices, or solid-state memory devices, for storing programs and routines executed by a processor of the computer to carry out various functionalities, as well as for storing configuration parameters and image data, interface circuits, and so forth.

In both digital and analog X-ray systems 10, the radiation source 16 is controlled by the control circuitry 74 via generation of signals corresponding to examination sequences. For example, the control circuitry 74 can inhibit the operation of the radiation source 16 if the correct examination conditions are not in place. In addition, the control circuitry 74 controls a power supply 78 that supplies power to the radiation source 16, light source 66, and camera 24, as well as to the control circuitry 74. Interface circuitry 80 facilitates the provision of power to the radiation source 16, light source 66, camera 24, and control circuitry 74. The power supply 78 also provides power to a mobile drive unit 82 (in mobile X-ray systems) to drive the movement of a wheeled base of the X-ray base station.

In the embodiment illustrated in FIG. 2, the control circuitry 74 is linked to at least one output device, such as the display or operator interface 34 having an autofill selection option 35. The output device may include standard or special purpose computer monitors and associated processing circuitry that may, for example, operate to display the autofill selection option 35 to the operator once image data has been acquired or received. The autofill selection option 35 may enable the operator to instruct the associated processing circuitry to automatically fill one or more sheets with the acquired data (which may be in multiple format types) in a spatial arrangement guided by previously received preferences, as described in more detail below.

Additionally, one or more operator workstations 32 (e.g., operator workstations corresponding to different X-ray and fluoroscopy systems) may be further linked in the system for outputting system parameters, requesting examinations, viewing images (e.g., in automatically generated spatially arrangements on one or more sheets), and so forth. In general, displays, printers, workstations, and similar devices supplied within the system may be local to the imaging components, or may be remote from these components, such as elsewhere within an institution or hospital, or in an entirely different location, linked to the imaging system 12 via one or more configurable networks, such as the Internet, virtual private networks, and so forth. The control circuitry 74 may also be linked to a speaker 44, which may provide audible signals, such as locator signals or patient-audible commands in certain embodiments.

Via the wireless interface 76, the imaging system 12 communicates wirelessly with one or more devices or systems. For example, in the illustrated embodiment, the wireless interface 76 enables communication with the medical facility network 48 and the printer 50. As before, the medical facility network 48 includes PACS 84, RIS 86, and/or HIS 88. In certain embodiments, the imaging system 12 may transmit subsets of the image data in an order that is automatically determined by the control circuitry 74 in accordance with a predetermined set of guidelines. Further, the control circuitry 74 may automatically fill one or more sheets with images of a patient's anatomy when the operator chooses the autofill option via the autofill selector 35 on the display 34.

In the illustrated embodiment, a series of automatically populated sheets 90 are shown. The automatically generated series 90 includes a first sheet 92 having a first image 94 and a second image 96 spatially arranged in a single row extending horizontally across the sheet 92. A second sheet 98 includes the first image 94 and the second image 96 spatially arranged in a vertical column extending down the sheet 98. Additionally, a third sheet 100 includes the first image 94 and the second image 96 arranged in a first horizontal row as well as a third image 102 and a fourth image 104 arranged in a second horizontal row across sheet 100. As such, each of the sheets 92, 98, and 100 includes a different spatial arrangement of images. The spatial arrangement of the images displayed on each of the sheets is automatically determined by the control circuitry 74 based on a stored or previously received guideline including a set of preferences. The foregoing feature may offer the benefit of reducing or eliminating the amount of time necessary for the operator to spend manually choosing the images to be displayed on each of the sheets. Further, as shown, the sheets 92, 98, and 100 may be physical sheets generated by the printer 50 or electronic sheets displayed or stored by the PACS 84, the RIS 86, or the HIS 88.

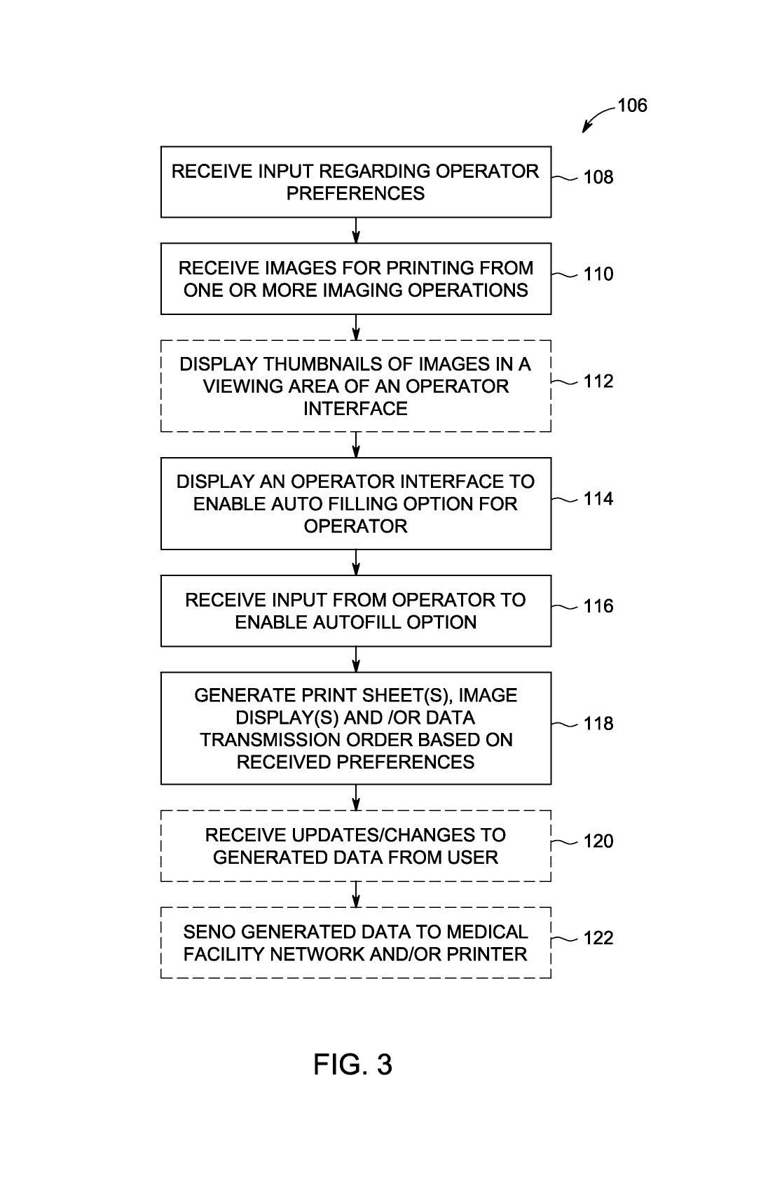

FIG. 3 is a flow chart illustrating a medical imaging analysis method 106 that may be executed by the control circuitry in certain embodiments to automatically produce the populated sheets in accordance with one or more preloaded preferences. The illustrated method 106 includes receiving input regarding one or more operator preferences (block 108). For example, in some embodiments, the operator may predefine preferences for image viewing based on factors such as patient anatomy, image type, radiologist, referring doctor, and so forth. For further example, the user may predefine that for images of the patient's abdomen, the images should be horizontally displayed in pairs, while for images of the patient's chest, the images should be vertically displayed in groups of three. In another embodiment, the user input preferences may call for a complete fluoroscopy image series to be separated into subsets including a certain quantity of images (e.g., approximately 16 images) and for each subset to be displayed in a horizontal row across separate sheets. Still further, in particular embodiments, the received input may not be received directly from a user, but rather may be accessed from memory, for example, from a stored set of guidelines.

Once the guidelines or preferences have been received, the circuitry receives images for printing from one or more imaging operations and/or systems (block 110). In some embodiments, the received images may have different formats and may be from different types of imaging modalities (e.g., some obtained via digital radiography and some obtained via fluoroscopy). Optionally, the received images may be displayed as thumbnails in a viewing area of an operator interface (block 112). This step may enable the operator to monitor the image analysis and display process to identify if an error has occurred.

Further, the method 106 includes displaying an operator interface to enable an autofilling option for the operator (block 114) and, subsequently, to receive input from the operator to enable the autofill capability (block 116). That is, once images are received, the control circuitry communicates the availability of the autofilling option to the operator via the user interface. The operator may then select the autofill option to indicate to the control circuitry that the operator desires that the sheets be automatically instead of manually generated based on the previously defined guidelines or preferences. Once the operator chooses the autofill mode, the circuitry automatically generates the print sheets, image displays, and/or data transmission order based on the predefined guidelines or preferences (block 118). That is, the circuitry automatically populates the sheets with the images in the spatial arrangements dictated by the guidelines. Again, this feature may increase the efficiency of the system since the operator does not have to manually choose which images to display in what manner on each of the sheets.

Nevertheless, in particular embodiments, it may be desirable for the circuitry to receive updates and/or changes to the generated sheets from the user (block 120). For example, the user may add additional sheets to the automatically generated sheets or may alter the quantity or arrangement of images on one or more of the sheets. Still further, in some embodiments, the method 106 may include sending the generated data to a medical facility network and/or a printer for display or printing (block 122). For instance, in one embodiment, the circuitry may generate a sheet including an ordered string of images in which the order of the images is defined based on the previously defined guidelines. This generated order of images may define the order in which the images are transmitted to a component of the medical facility network.

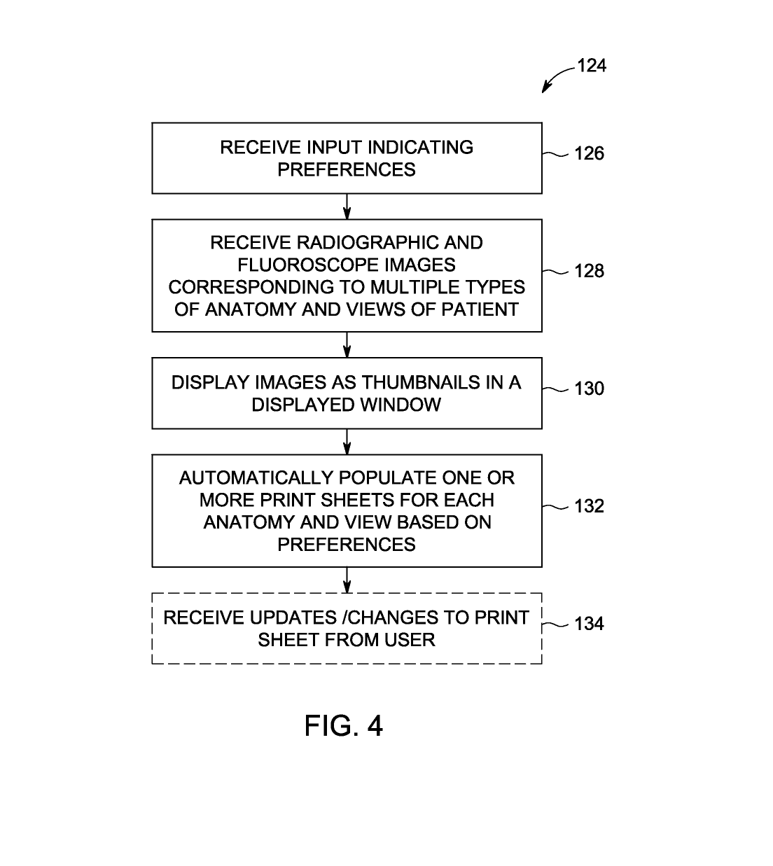

FIG. 4 is a flow chart illustrating an additional medical imaging analysis method 124 that may be executed by the control circuitry in certain embodiments to automatically produce the populated sheets from image data acquired via digital radiography and fluoroscopy. The method 124 includes receiving input indicating preferences or guidelines for the filling of image sheets (block 126). For example, this step 126 may include receiving input from a user via a user interface regarding the desired quantity and spatial arrangement of the images to be displayed on each sheet. The method 124 further includes receiving the radiographic and fluoroscopic images corresponding to multiple anatomies and views of a patient (block 128) and displaying the received images as thumbnails in a displayed window (block 130).

Once received and displayed, the images are processed to automatically populate one or more print sheets for each anatomy and view based on the input preferences (block 132). For example, identifying information corresponding to each of the received images may be analyzed to group the images in accordance with the received guidelines. That is, the images may be processed according to an associated identification tag, which may include information such as the image type (e.g., radiographic, fluoroscopic, etc.), the acquired view, the anatomy shown in the image, and so forth. After populating the print sheets in this manner, the user may be prompted for updates or changes to the automatically generated sheets (block 134). For example, the user may alter the format of the sheets, shift images between sheets to regroup the images, add additional sheets of images by selecting images from the displayed thumbnails, and so forth.

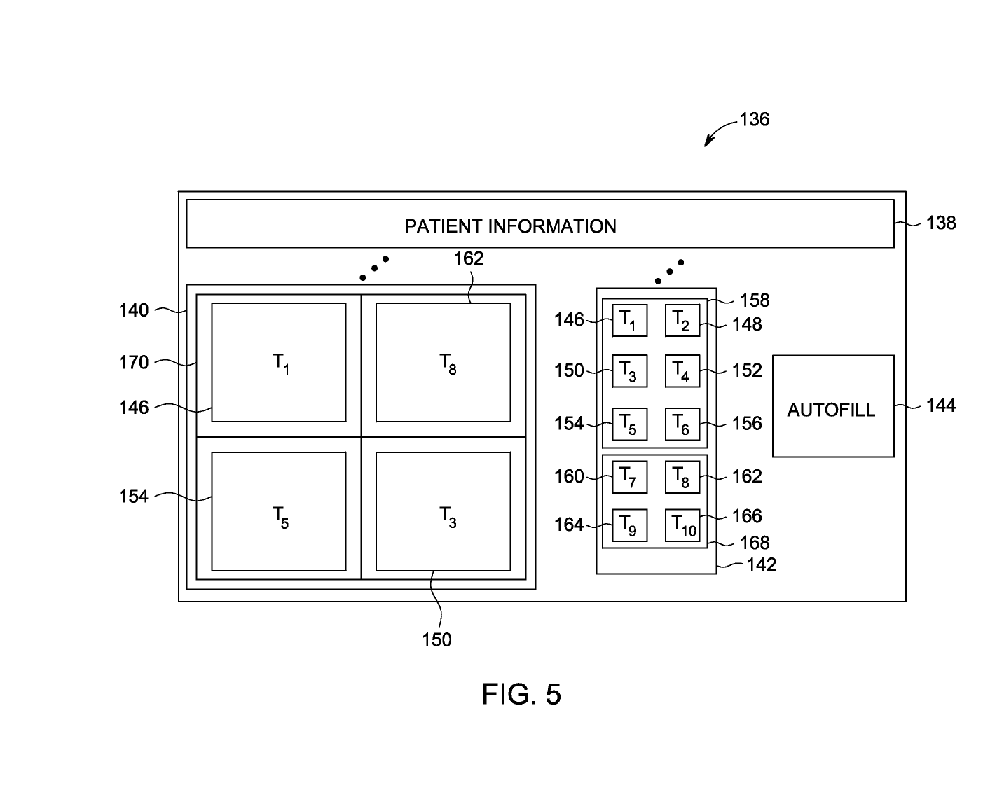

FIG. 5 is a diagrammatical illustration depicting an embodiment of an operator interface 136 that may be utilized by an operator of the presently disclosed systems. More specifically, the illustrated interface 136 includes a patient information bar 138, a sheet display block 140, a thumbnail display block 142, and an autofill selector 144. The thumbnail display block 142 includes thumbnail images 146, 148, 150, 152, 154, and 156 grouped in a block 158 corresponding to a first imaging operation. The thumbnail display block 142 also includes thumbnail images 160, 162, 164, and 166 grouped in a block 168 corresponding to a second imaging operation. For example, the first block 158 of images may have been acquired via digital radiography with the patient positioned in a first position between the radiation source and the detector, whereas the second block 168 of images may have been acquired after the patient was moved to a second position in the digital radiography system. It should be noted that any number of thumbnail images from any number of imaging operations may be acquired and displayed, for example, in the block 142, which may enable the user to scroll through the plurality of acquired images.

Further, the illustrated sheet display block 140 shows one sheet 170 including images 146 and 162 spatially arranged in a first row and images 154 and 150 spatially arranged in a second row below the first row. The sheet 170 may be automatically generated when the user utilizes the autofill selector 144 to direct the circuitry to automatically generate image sheets in accordance with received or stored guidelines. However, additional sheets may also be generated, and each of the sheets may be displayed one at a time in block 140. Still further, the display block 140 may enable the operator to update or change the automatically generated sheets. For example, the operator may remove one of the displayed images and replace it with another image. Such a feature may be advantageous, for example, in instances in which one of the displayed images was acquired during a system malfunction. In such cases, the user may replace the error image with an image acquired during normal operational conditions of the imaging system. Nevertheless, the sheets 170 are automatically generated by the processing or control circuitry when the user utilizes the autofill selector 144 to place the system in autofill mode.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A medical imaging analysis method, comprising:
receiving a data input indicative of one or more image display preferences;
receiving image data encoding medical images in one or more formats from one or more radiographic imaging operations;
receiving input from an operator enabling an autofill operation; and
automatically populating one or more sheets with a subset of the image data in a spatial arrangement determined by the one or more image display preferences.

2. The method of claim 1, wherein the one or more sheets comprise a printer sheet, an electronic display sheet, an electronic sheet defining an order in which portions of the subset of image data are to be exported, or a combination thereof.

3. The method of claim 1, wherein the one or more radiographic imaging operations comprises digital radiography, film radiography, fluoroscopy, or a combination thereof.

4. The method of claim 1, comprising receiving and implementing an update to the automatically populated one or more sheets from a user.

5. The method of claim 1, comprising transmitting the automatically populated one or more sheets to a medical facility component comprising a picture archiving communication system (PACS), a radiology information system (RIS), a hospital information system (HIS), or a combination thereof.

6. The method of claim 1, wherein the image display preferences comprise predefined spatial arrangements based on imaged anatomy, protocol type, image type, or a combination thereof.

7. The method of claim 1, comprising converting the received image data to a digital imaging and communications in medicine (DICOM) standard format.

8. A medical imaging system, comprising:
an imager configured to acquire image data indicative of a region of interest in a patient;
an operator interface configured to receive one or more operator selections corresponding to operator printing and/or display preferences for the acquired image data;
control circuitry communicatively coupled to the operator interface and configured to display an autofill selector on the operator interface to enable the operator to select an autofill option; and
wherein when the operator enables the autofill option, the control circuitry is adapted to automatically populate one or more sheets with a subset of the image data in a spatial arrangement determined by the one or more operator selections.

9. The system of claim 8, wherein the one or more sheets comprise a printer sheet, an electronic display sheet, an electronic sheet defining an order in which portions of the subset of image data are to be exported, or a combination thereof.

10. The system of claim 8, wherein the control circuitry is configured to display thumbnail images of the anatomical views encoded in the image data on the operator interface for viewing.

11. The system of claim 8, wherein when the one or more sheets are automatically populated, the control circuitry is configured to display an update option on the operator interface to enable the operator to alter the spatial arrangement of the subset of the image data on the one or more sheets.

12. The system of claim 8, wherein the operator interface is configured to transmit the one or more sheets to a medical facility network comprising a picture archiving communication system (PACS), a radiology information system (RIS), a hospital information system (HIS), or a combination thereof.

13. The system of claim 8, wherein each of the one or more sheets corresponds to a portion of the anatomy of the patient, a perspective view type of the acquired image, the region of interest of the patient, or a combination thereof.

14. The system of claim 8, wherein the imager comprises a digital X-ray device, a fluoroscopy device, or a combination thereof.

15. A medical imaging system, comprising:
an operator workstation configured to enable an operator to operate a medical imaging device in accordance with operator preferences; and
control circuitry configured to display an operator interface on a display portion of the operator workstation to enable an autofilling option for the operator; and
wherein when the operator selects the autofilling option, the control circuitry is configured to automatically populate a sheet with a series of acquired medical images in a spatial arrangement determined based on predetermined preferences.

16. The system of claim 15, wherein the series of acquired medical images comprise images of a patient's anatomy acquired in more than one type of image format.

17. The system of claim 15, wherein the sheets comprises a printer sheet, an electronic display sheet, an electronic sheet defining an order in which portions of the subset of image data are to be exported, or a combination thereof.

18. The system of claim 15, wherein the control circuitry is configured to display a submenu on the operator interface that enables the operator to alter the spatial arrangement of the acquired medical images on the sheet.

19. The system of claim 15, wherein the control circuitry is configured to export the sheet to a printing device for printing of the sheet.

20. The system of claim 15, wherein the control circuitry is configured to export the sheet to a picture archiving communication system (PACS) for storage and/or display.
